(19) United States
(12) Patent Application Publication
(10) Pub. No.: US 2021/0188162 A1
(43) Pub. Date: Jun. 24, 2021

(54) VEHICLE STATE ALERT APPARATUS AND VEHICLE STATE ALERT METHOD

(71) Applicant: Panasonic Intellectual Property Management Co., Ltd., Osaka (JP)

(72) Inventor: Shinichi YOSHIZAWA, Osaka (JP)

(73) Assignee: Panasonic Intellectual Property Management Co., Ltd., Osaka (JP)

(21) Appl. No.: 17/099,108

(22) Filed: Nov. 16, 2020

(30) Foreign Application Priority Data
Dec. 18, 2019 (JP) 2019-228314

(51) Int. Cl. B60Q 1/52; B60Q 5/00; B60W 40/08; B60W 50/16; B60W 60/00

(52) U.S. Cl. CPC B60Q 1/52; B60Q 5/00; B60W 40/08; B60W 2540/229; B60W 60/00186; B60W 2040/0827; B60W 50/16

(57) ABSTRACT

A vehicle state alert apparatus is used in a vehicle including a vehicle exterior alert apparatus capable of making an alert to a person outside the vehicle, and includes: a state determiner that determines a state of a driver of the vehicle and a state of the vehicle; and an alert controller that causes the vehicle exterior alert apparatus to make a state alert for communicating the states determined by the state determiner. The states determined by the state determiner include a first state in which an emergency situation is likely to occur and a second state in which the first state is likely to occur, and the alert controller controls a travel state of the vehicle in accordance with the states determined by the state determiner.

### CROSS REFERENCE TO RELATED APPLICATION

The present application is based on and claims priority of Japanese Patent Application No. 2019-228314 filed on Dec. 18, 2019.

### FIELD

The present disclosure relates to a vehicle state alert apparatus.

### BACKGROUND

PTL 1 discloses a vehicle state alert apparatus which, when an abnormality with a driver has been detected, provides information so that people outside the vehicle can take appropriate actions such as avoiding the vehicle.

### CITATION LIST

### Patent Literature

PTL 1: Japanese Unexamined Patent Application Publication No. 2016-115144

### SUMMARY

However, the vehicle state alert apparatus according to PTL 1 can be improved upon.

In view of this, the present disclosure provides a vehicle state alert apparatus capable of further improving upon the related art.

A vehicle state alert apparatus according to one aspect of the present disclosure is used in a vehicle including a vehicle exterior alert apparatus capable of making an alert to a person outside the vehicle, and includes: a state determiner that determines a state of a driver of the vehicle and a state of the vehicle; and an alert controller that causes the vehicle exterior alert apparatus to make a state alert for communicating the states determined by the state determiner. The states determined by the state determiner include a first state in which an emergency situation is likely to occur and a second state in which the first state is likely to occur, and the alert controller controls a travel state of the vehicle in accordance with the states determined by the state determiner.

A vehicle state alert method according to one aspect of the present disclosure is used in a vehicle including a vehicle exterior alert apparatus capable of making an alert to a person outside the vehicle, and includes: determining a state of a driver of the vehicle and a state of the vehicle; and causing the vehicle exterior alert apparatus to make a state alert for communicating the determined states, and controlling a travel state of the vehicle in accordance with the determined states. The determined states include a first state in which an emergency situation is likely to occur and a second state in which the first state is likely to occur.

Note that these comprehensive or specific aspects may be realized by a system, a method, an integrated circuit, a computer program, or a computer-readable recording medium such as a CD-ROM, or may be implemented by any desired combination of systems, devices, methods, integrated circuits, computer programs, and recording media.

The vehicle state alert apparatus according to one aspect of the present disclosure is capable of further improving upon the related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating the configuration of a vehicle according to Embodiment 1.

FIG. 2 is a flowchart illustrating an example of operations in state alert processing according to Embodiment 1.

FIG. 3 is a block diagram illustrating the configuration of a vehicle according to Embodiment 2.

FIG. 4 is a flowchart illustrating an example of operations in state alert processing according to Embodiment 2.

### DESCRIPTION OF EMBODIMENTS

Embodiments will be described in detail hereinafter with reference to the drawings where appropriate. However, descriptions which are more detailed than necessary will not be given. For example, detailed descriptions of matters which are already well-known, redundant descriptions of substantially identical configurations, and so on may be omitted. This is to avoid unnecessary redundancy in the descriptions and facilitate understanding for those skilled in the art.

Note that the accompanying drawings and the following descriptions have been provided so that those skilled in the art can sufficiently understand the present disclosure, and as such the content of the scope of claims is not intended to be limited by the drawings and descriptions in any way.

### Embodiment 1

A vehicle state alert apparatus according to Embodiment 1 will be described hereinafter with reference to the drawings.

### 1-1. Configuration

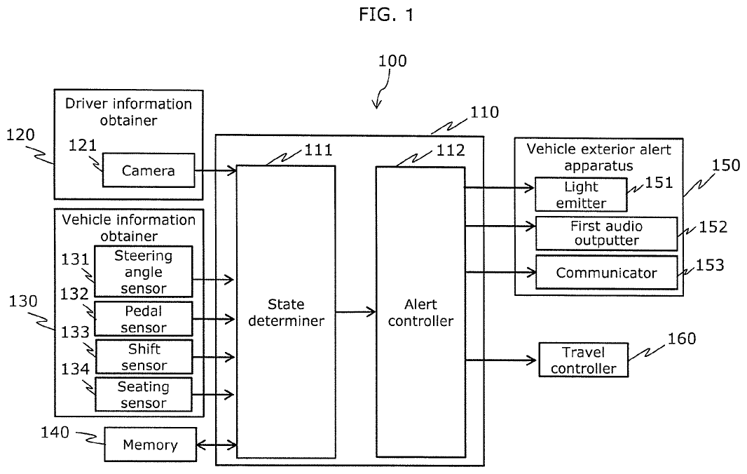

FIG. 1 is a block diagram illustrating the configuration of a vehicle according to Embodiment 1.

As illustrated in FIG. 1, vehicle 100 includes vehicle state alert apparatus 110, driver information obtainer 120, vehicle information obtainer 130, memory 140, vehicle exterior alert apparatus 150, and travel controller 160.

Vehicle state alert apparatus 110 determines a state of a driver and a state of vehicle 100, alerts the exterior of the state of the driver and the state of vehicle 100 in accordance with a determination result (a first state, a second state, or another state), and controls the travel of vehicle 100. Vehicle state alert apparatus 110 is an electric circuit. Vehicle state alert apparatus 110 can be implemented by, for example, one or more processors (microprocessors) and one or more memories. In other words, by executing one or more programs stored in one or more memories, the one or more processors function as the vehicle state alert apparatus. The one or more programs may be stored in memory in advance, or may be provided over a telecommunication line such as the Internet or having been recorded in a non-transitory recording medium such as a memory card.

Vehicle state alert apparatus 110 includes state determiner 111 and alert controller 112. State determiner 111 and alert controller 112 are not physical configurations, but are rather functions realized by vehicle state alert apparatus.

State determiner 111 determines the state of the driver driving the vehicle and the state of the vehicle on the basis of driver information output by driver information obtainer 120, vehicle information output by vehicle information obtainer 130, and data recorded in memory 140. The states determined by state determiner 111 include the first state, which is a state in which an emergency situation is likely to occur, and the second state, which is a state in which the first state is likely to occur.

Alert controller 112 causes vehicle exterior alert apparatus 150 to make a state alert for communicating the state determined by state determiner 111. Alert controller 112 also controls a travel state of vehicle 100 in accordance with the state determined by state determiner 111. Alert controller 112 outputs a control signal for causing vehicle exterior alert apparatus 150 and travel controller 160 to make the state alert based on the state determined by state determiner 111. The “state alert” mentioned here is an alert made automatically by vehicle state alert apparatus 110 after determining the state of the driver and the state of vehicle 100, and does not include alerts made in response to an operation made by the driver in response to a determination made by the driver. Passing, sounding the horn, and so on can be given as examples of alerts made in response to an operation by the driver. Additionally, operations of vehicle 100 according to the determined condition are speed control for reducing accidents, moving to a safe location and stopping, and so on.

Driver information obtainer 120 obtains the driver information indicating the state of the driver. Driver information obtainer 120 outputs the obtained driver information to state determiner 111 of vehicle state alert apparatus 110. In the present embodiment, camera 121 is used as the driver information obtainer. Driver information obtainer 120 may include a biometric sensor, a heartbeat sensor, a pressure sensor installed in the driver's seat, or the like, in addition to camera 121.

Camera 121 is an image sensor such as a complementary metal oxide semiconductor (CMOS) image sensor or a charge coupled device (CCD) image sensor. Camera 121 is installed in a position at which the driver's face can be captured from the front. Camera 121 captures an image of the driver's face and outputs the image to state determiner 111.

Vehicle information obtainer 130 is constituted by a sensor that detects a state of operations made by the driver with respect to vehicle 100, a sensor that detects a state of the vehicle, and the like, and outputs a result of the detection to state determiner 111 of vehicle state alert apparatus 110. In the present embodiment, steering angle sensor 131, pedal sensor 132, shift sensor 133, and seating sensor 134 serve as vehicle information obtainer 130.

Steering angle sensor 131 detects a steering angle of a steering wheel of vehicle 100 and outputs a result of the detection to state determiner 111. Pedal sensor 132 detects an amount by which an accelerator pedal of vehicle 100 is being depressed and outputs a result of the detection to state determiner 111. Shift sensor 133 detects an operation position (shift position) of a shift lever operated by the driver and outputs a result of the detection to state determiner 111. Seating sensor 134 detects whether or not a person is sitting in the driver's seat and outputs a result of the detection to state determiner 111. Note that vehicle information obtainer 130 is not limited to steering angle sensor 131, pedal sensor 132, shift sensor 133, and seating sensor 134, and a vehicle speed sensor that detects the speed of the vehicle, a sensor or the like that detects the tilt of the vehicle, or the like may be included as well.

Memory 140 is used to store various types of information required by vehicle state alert apparatus 110. Memory 140 is read-only memory (ROM), random access memory (RAM), electrically erasable programmable read-only memory (EEPROM), or the like. Memory 140 records data of past operation states of vehicle 100. Memory 140 may record statistical data created from the data of past operation states, various types of data calculated from the data of past operation states, and the like.

Vehicle exterior alert apparatus 150 is an apparatus capable of making a state alert to a person outside vehicle 100 (a pedestrian, the driver of another vehicle, and the like). Vehicle exterior alert apparatus 150 according to Embodiment 1 includes light emitter 151, first audio outputter 152, and communicator 153.

Light emitter 151 makes a state alert to the exterior by emitting light. Light emitter 151 is, for example, a headlight, a taillight, a brake light, a hazard light, a turn signal light, or the like, for example, which is capable of making a state alert by flashing.

First audio outputter 152 makes a state alert to the exterior by outputting audio. First audio outputter 152 is, for example, a speaker capable of making an alert by outputting audio, a horn capable of making an alert by sounding, or the like.

Communicator 153 has a wireless communication function for communicating wirelessly using a mobile communication network (not shown), and also has a function for performing vehicle-to-vehicle communication with another vehicle present outside vehicle 100 using the mobile communication network, a function for communicating with a mobile terminal present outside vehicle 100, and a function for performing road-to-vehicle communication with roadside equipment (e.g., VICS (registered trademark) or the like).

The vehicle exterior alert apparatus is not limited to light emitter 151, first audio outputter 152, and communicator 153, and may also be a display installed on the outside of vehicle 100 and capable of making a state alert using text, images, or the like.

Travel controller 160 controls the travel of vehicle 100. Travel controller 160 includes a vehicle driving system, such as motors and the like, which control the steering, speed, braking, and so on of vehicle 100.

### 1-2. State Determination

The state of the driver and the state of vehicle 100 determined by state determiner 111 will be described next.

### 1-2-1. State of Driver

In the present embodiment, state determiner 111 determines whether or not the driver is in a distracted state. “Distracted state” refers to a state in which the driver's concentration or attention is reduced. In the present embodiment, a highly-drowsy state in the distracted state corresponds to the first state in which it is highly likely that an emergency situation will arise, and the distracted state is determined by determining whether or not the driver is in a highly-drowsy state. The highly-drowsy state is a state in which the driver's drowsiness level is at least a predetermined level. State determiner 111 determines whether the driver's eyes are open or closed in an image of the driver's face captured by camera 121, and determines that the driver is in a highly-drowsy state when the driver's eyes have remained closed for at least a predetermined length of time. The predetermined length of time is five seconds, for example. The highly-drowsy state may be determined on the basis of the degree to which the driver's eyes are open, how frequently the driver yawns, how frequently the driver blinks, and so on.

Note that the highly-drowsy state and a state in which the highly-drowsy state is likely to occur (the distracted state) may be determined using information on the steering angle obtained from steering angle sensor 131, the direction in which the driver's face is facing detected from an image of the driver's face captured by camera 121, a heart rate obtained from the heartbeat sensor (not shown), and a slope of the driver's posture detected from the pressure sensor (not shown) installed in the driver's seat.

### 1-2-2. State of Vehicle

In the present embodiment, state determiner 111 determines whether or not vehicle 100 is in an extended travel state.

State determiner 111 determines whether or not vehicle 100 has been traveling for an extended period of time. The extended travel state is a state in which vehicle 100 has been traveling for at least a predetermined length of time. The extended travel state corresponds to the second state in which the first state (the highly-drowsy state) is likely to occur. State determiner 111 determines whether or not the driver is sitting in the driver's seat on the basis of a result of a determination made using seating sensor 134. Additionally, state determiner 111 determines a state of the shift position on the basis of a detection signal from shift sensor 133, obtained by vehicle information obtainer 130. State determiner 111 determines that the state of vehicle 100 is the extended travel state when the shift position is in “drive” and the driver has been sitting in the driver's seat for at least a predetermined length of time. The predetermined length of time is two hours, for example. If state determiner 111 determines from a navigation device (not shown) or the like that the vehicle is traveling on a monotonous road, such as a highway or the like having continuous straight sections of road, the driver is more likely to fall into a distracted state in a short length of time, and thus the predetermined length of time may be shortened.

### 1-3. Operations

Operations of vehicle state alert apparatus 110 according to Embodiment 1 will be described next.

### 1-3-1. Flow of Operations

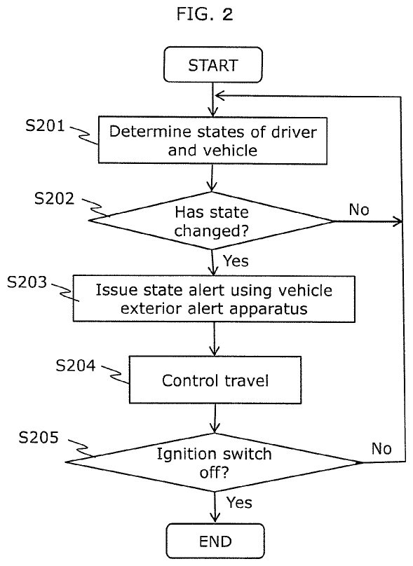

FIG. 2 is a flowchart illustrating an example of operations for the state alert according to Embodiment 1.

The state alert processing from steps S201 to S205 illustrated in FIG. 2 starts when an ignition switch of vehicle 100 is turned on, and is repeated until the ignition switch is turned off.

When the ignition switch is turned on, camera 121 captures an image of the driver's face and outputs the captured face image to state determiner 111. Additionally, steering angle sensor 131, pedal sensor 132, shift sensor 133, and seating sensor 134 obtain the operation state of vehicle 100, a state within the vehicle, and so on, and output the obtained sensor information to state determiner 111. The face image, the sensor information, and the like may be recorded as historical data in memory 140.

State determiner 111 determines the state of the driver and the state of vehicle 100 on the basis of the face image output from camera 121 and the sensor information input from the sensors. When the result of the previous determination (the first state, the second state, or another state), recorded in memory 140, is different from the result of the current determination, state determiner 111 determines that the state has changed (step S201). Note that state determiner 111 determines that the state has changed if, in the first determination, the state of the driver is the first state (the distracted state, which in the present embodiment is the highly-drowsy state), or if the state of vehicle 100 is the second state (the extended travel state).

If it is determined that the state has not changed (“No” in step S202), state determiner 111 records the determination result in memory 140, and the sequence returns to step S201. At this time, state determiner 111 may output an indication that the state has not changed to alert controller 112. If a determination result indicating that there are no changes in the states of the driver and vehicle 100 has been input, alert controller 112 continues the current alert control.

If it is determined that the state has changed (“Yes” in step S202), state determiner 111 outputs the result of the determination to alert controller 112. Alert controller 112 causes vehicle exterior alert apparatus 150 to make a state alert for communicating the state determined by state determiner 111. Alert controller 112 causes vehicle exterior alert apparatus 150 to make different state alerts for the first state and the second state. Alert controller 112 causes vehicle exterior alert apparatus 150 to make the state alerts in formats so that the alert for the first state has a higher urgency than the alert for the second state. Note that alert controller 112 may perform control so that the state alert is made to the exterior of the vehicle only when the state has changed to the first state (step S203).

Alert controller 112 controls the travel state of vehicle 100 in accordance with the state determined by state determiner 111. When making an alert of the first state, alert controller 112 controls travel controller 160 to decelerate vehicle 100. When making an alert of the second state, alert controller 112 sets an upper limit speed on the basis of the speed limit of the road on which vehicle 100 is currently traveling, the state outside vehicle 100, and so on, and controls vehicle 100 when the current speed of vehicle 100 exceeds the upper limit speed. Note that alert controller 112 may control the travel state only when the state has changed to the first state.

Additionally, alert controller 112 may control travel controller 160 to stop vehicle 100 when making an alert of the first state, and may control travel controller 160 to decelerate vehicle 100 when making an alert of the second state.

Furthermore, alert controller 112 may control travel controller 160 to stop vehicle 100 when making an alert of the first state, and may control travel controller 160 to avoid suddenly accelerating vehicle 100 when making an alert of the second state.

Further still, alert controller 112 may control travel controller 160 to stop vehicle 100 when making an alert of the first state, and may control travel controller 160 to control the steering of vehicle 100 when making an alert of the second state.

Additionally, alert controller 112 may control travel controller 160 to perform autonomous travel (steering control, speed control, lane change control) on the basis of the state outside vehicle 100 when making an alert of the first state, and may set an upper limit speed on the basis of the speed limit of the road on which vehicle 100 is currently traveling, the state outside vehicle 100, and so on, and control the speed of vehicle 100 so that the current speed of vehicle 100 does not exceed the upper limit speed, when making an alert of the second state.

Additionally, alert controller 112 may control travel controller 160 to stop vehicle 100 on the shoulder when making an alert of the first state, and may control vehicle 100 to change lanes so as to move to a traveling lane (the lane closest to the shoulder) when making an alert of the second state.

Additionally, when making an alert of the first state, alert controller 112 may control travel controller 160 to stop vehicle 100. Alert controller 112 may determine whether or not to cause vehicle 100 to perform an evacuation operation before causing vehicle 100 to stop, on the basis of the state outside vehicle 100. “Evacuation operation” refers to moving vehicle 100 to an evacuation location where vehicle 100 will not inhibit traffic. The evacuation location is, for example, the shoulder of the road, but if the shoulder is narrow, the evacuation location may be a straight portion of the road or a portion of the road where the lane section is wider than the rest of the road. When it is determined that the evacuation operation can be performed before stopping vehicle 100, alert controller 112 outputs, to travel controller 160, a control signal for causing vehicle 100 to perform the evacuation operation of moving to the evacuation location and stopping. However, when it is determined that vehicle 100 cannot perform the evacuation operation, alert controller 112 outputs a control signal to travel controller 160 for causing vehicle 100 to stop without vehicle 100 performing the evacuation operation. In this case, travel controller 160 causes vehicle 100 to stop on the road on which vehicle 100 is currently traveling at the shortest possible distance, for example, without causing vehicle 100 to perform the evacuation operation (step S204).

State determiner 111 determines whether or not the ignition switch is off (step S205). If state determiner 111 determines that the ignition switch is off (“Yes” in step S205), the determination result is recorded into memory 140 and the state determination processing ends; if it is determined that the ignition switch is not off (“No” in step S205), the determination result is recorded into memory 140, the sequence returns to step S201, and the processing from step S201 and on is repeated.

### 1-3-2. Examples of Operations

Alert operations which alert controller 112 causes vehicle exterior alert apparatus 150 to perform will be described hereinafter.

### Alert Using Light Emitter

Alert controller 112 causes light emitter 151 to make a state alert for communicating the state determined by state determiner 111. Alert controller 112 outputs a control signal to light emitter 151. The control signal includes parameter information such as the brightness, color, and display interval of the light emitted by light emitter 151. Alert controller 112 controls at least one of the parameter information according to the state determined by state determiner 111.

Alert controller 112 may control light emitter 151 only when making an alert of the first state. For example, alert controller 112 may cause light emitter 151 to change brightness only when making an alert of the first state. Alternatively, alert controller 112 may cause light emitter 151 to change color only when making an alert of the first state. Furthermore, alert controller 112 may cause light emitter 151 to flash only when making an alert of the first state.

Alert controller 112 may cause light emitter 151 to perform different types of alerts between the first state and the second state. Alert controller 112 may control the brightness of light emitter 151 when making an alert of the first state to be brighter than the brightness used when making an alert of the second state. Additionally, alert controller 112 may control the interval of flashing of light emitter 151 when making an alert of the first state to be shorter than the interval of flashing used when making an alert of the second state. Furthermore, alert controller 112 may make the color of the light emitted by light emitter 151 when making an alert of the first state a color evoking a greater sense of urgency (e.g., red or a color close to red) than the color of the light emitted when making an alert of the second state.

For example, alert controller 112 may make the state alert to the outside of the vehicle by controlling the brightness and interval of flashing of the headlights. Additionally, alert controller 112 may make the state alert to the outside of the vehicle by flashing the hazard lights or controlling the interval of the flashing. Furthermore, alert controller 112 may make the state alert to the outside of the vehicle by lighting the brake lights, flashing the brake lights, or controlling the interval of the flashing. Additionally, alert controller 112 may light or control the flashing of the brake lights when the travel state is controlled, such as when decelerating. Furthermore, alert controller 112 may make the state alert by flashing the turn signal light in the direction of steering when the steering is controlled.

### Alert Using Audio Outputter

Alert controller 112 causes first audio outputter 152 to make a state alert for communicating the state determined by state determiner 111. Alert controller 112 may cause first audio outputter 152 to output audio only when making an alert of the first state. Alert controller 112 causes first audio outputter 152 to output audio to alert other vehicles, pedestrians, and the like outside vehicle 100. For example, alert controller 112 may sound the horn only when the first state is determined. Additionally, when travel control is performed, alert controller 112 may cause audio indicating the details of the travel control to be output.

### Alert Using Communicator

Alert controller 112 makes a state alert, for communicating the state determined by state determiner 111, through communicator 153. Alert controller 112 makes the state alert to another vehicle outside through vehicle-to-vehicle communication via communicator 153. The other vehicle that receives the state alert can alert the driver in the vehicle using devices installed in the vehicle (a speaker, a navigation device, or the like). Alert controller 112 may make the state alert to a mobile terminal, such as a smartphone, held by a pedestrian outside the vehicle, an occupant of another vehicle, or the like, via communicator 153. The format of the state alert made by alert controller 112 to the outside of the vehicle is an image, audio, a text message, or the like. Furthermore, when travel control is performed, alert controller 112 may make a state alert indicating the details of the travel control to other vehicles outside through vehicle-to-vehicle communication performed via communicator 153.

### 1-4. Effects, Etc.

As described thus far, in the present embodiment, state determiner 111 determines the state of the driver driving vehicle 100 and the state of vehicle 100, and alert controller 112 causes vehicle exterior alert apparatus 150 to make a state alert for communicating the state determined by state determiner 111. Alert controller 112 also controls a travel state of vehicle 100 in accordance with the state determined by state determiner 111.

Accordingly, when it is determined that there is an abnormality in the state of the driver driving vehicle 100 and in the state of vehicle 100, an alert of the state of the driver driving vehicle 100 and of the state of vehicle 100 can be made to other vehicles, pedestrians, and so on outside vehicle 100. Vehicle 100 itself can also travel in accordance with the state of the driver and the state of vehicle 100.

This enables those outside vehicle 100 and vehicle 100 itself to take appropriate action to avoid danger. Furthermore, the driver of vehicle 100 is aware that their own state is being communicated to the exterior, which encourages the driver to drive safely.

Additionally, in the present embodiment, state determiner 111 determines the first state, in which an emergency situation is likely to occur, and the second state, in which the first state is likely to occur, and alert controller 112 communicates the first state and the second state to the exterior.

Accordingly, vehicle 100 and those outside vehicle 100 can foresee, at an early stage, the possibility of an emergency situation occurring. This provides more time for vehicle 100 and those outside vehicle 100 to consider measures, such as evasive action, to respond to the emergency situation.

Additionally, in the present embodiment, alert controller 112 causes vehicle exterior alert apparatus 150 to continually make the state alert based on the result of the determination by state determiner 111, at least while the driver is driving vehicle 100. This makes it possible for state determiner 111 to determine not only the first state, but also the second state in which the first state is likely to occur. As such, vehicle 100 and those outside vehicle 100 can foresee, at an early stage, the possibility of an emergency situation occurring.

Additionally, in the present embodiment, alert controller 112 controls vehicle 100 to decelerate when state determiner 111 makes an alert of the first state. This makes it possible for the vehicle itself to travel appropriately when the driver driving vehicle 100 is in an abnormal state. This in turn makes it possible to reduce the occurrence of accidents.

Additionally, in the present embodiment, alert controller 112 controls vehicle 100 to stop when state determiner 111 makes an alert of the first state. This makes it possible for the vehicle itself to travel appropriately when the driver driving vehicle 100 is in an abnormal state. This in turn makes it possible to reduce the occurrence of accidents.

Additionally, in the present embodiment, alert controller 112 makes the state alert by causing light emitter 151 to emit light. Alternatively, alert controller 112 makes the state alert by changing the brightness, interval of flashing, or color of the light emitted by light emitter 151. This makes it possible for an effective alert to be made to the exterior of vehicle 100 even when it is dark around vehicle 100, such as at night. When light emitter 151 is a hazard light or a brake light, the driver of a following vehicle can recognize the possibility of an emergency situation at an early stage, and therefore can take action to avoid a collision at an early stage. This is particularly effective when alert controller 112 controls the travel state, such as deceleration. Alternatively, alert controller 112 makes the state alert by flashing a turn signal light, which serves as light emitter 151, in the direction of steering. As such, pedestrians outside vehicle 100 and drivers of other vehicles can predict the direction in which vehicle 100 will travel and can therefore take appropriate action for avoiding a collision with vehicle 100. Alternatively, alert controller 112 causes first audio outputter 152 to output the details of the travel control using audio. As such, pedestrians outside vehicle 100 and drivers of other vehicles can predict the travel state of vehicle 100 and can therefore take appropriate action for avoiding a collision with vehicle 100. Alternatively, when travel control is performed, alert controller 112 makes a state alert indicating the details of the travel control to other vehicles outside through vehicle-to-vehicle communication performed via communicator 153. As such, other vehicles outside vehicle 100 and drivers of other vehicles can predict the travel state of vehicle 100 and can therefore take appropriate action for avoiding a collision with vehicle 100.

Additionally, in the present embodiment, alert controller 112 makes the state alert by causing first audio outputter 152 to output audio. Through this, a state alert of vehicle 100 can be made to pedestrians and other vehicles outside vehicle 100 even without the pedestrians and other vehicles looking at vehicle exterior alert apparatus 150. This makes it possible to reduce the likelihood of disturbing the walking and driving of pedestrians outside vehicle 100 and drivers of other vehicles. When the audio output is the sound of the horn, everyone is more likely to believe that an emergency situation is occurring, and can therefore be aware of the possibility of an emergency situation at an early stage.

Additionally, in the present embodiment, alert controller 112 communicates an alert to an external device via communicator 153.

Through this, a state alert of vehicle 100 can be made to pedestrians and other vehicles outside vehicle 100. As such, pedestrians outside vehicle 100 and drivers of other vehicles can take appropriate action in accordance with the state of vehicle 100. When it is difficult to notice the audio output from the vehicle, such as when a pedestrian outside is listening to music on headphones, making the state alert through the pedestrian's headphones makes it possible to alert the pedestrian of the possibility that an emergency situation is occurring. Furthermore, making the state alert to the cabin of another vehicle makes it possible to alert the driver of the other vehicle that an emergency situation is occurring, even when the other vehicle has robust sound insulation. As such, even if there are visual obstructions that make it difficult to notice the state alert output from the vehicle, the possibility that an emergency situation will occur can be noticed from an early stage.

### Embodiment 2

A vehicle state alert apparatus according to Embodiment 2 will be described hereinafter with reference to the drawings.

### 2-1. Configuration

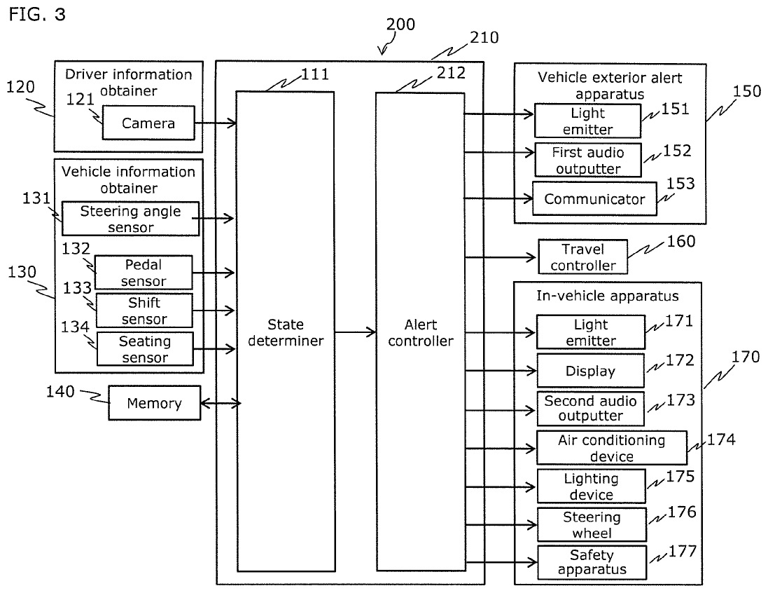

FIG. 3 is a block diagram illustrating the configuration of a vehicle according to Embodiment 2.

As illustrated in FIG. 3, vehicle 200 includes vehicle state alert apparatus 210, driver information obtainer 120, vehicle information obtainer 130, memory 140, vehicle exterior alert apparatus 150, travel controller 160, and in-vehicle apparatuses 170. In FIG. 3, constituent elements that perform the same operations as those in FIG. 1 are given the same reference signs, and will not be described.

Vehicle state alert apparatus 210 determines a state of a driver and a state of vehicle 200, determines the state of the driver and the state of vehicle 200 in accordance with a determination result (a first state, a second state, or another state), alerts the exterior of the state of the driver and the state of vehicle 200 in accordance with the determination result, and controls the travel of vehicle 200. Vehicle state alert apparatus 210 is an electric circuit. Vehicle state alert apparatus 210 can be implemented by, for example, one or more processors (microprocessors) and one or more memories. In other words, by executing one or more programs stored in one or more memories, the one or more processors function as the vehicle state alert apparatus. The one or more programs may be stored in memory in advance, or may be provided over a telecommunication line such as the Internet or having been recorded in a non-transitory recording medium such as a memory card.

Vehicle state alert apparatus 210 includes state determiner 111 and alert controller 212. State determiner 111 and alert controller 212 are not physical configurations, but are rather functions realized by vehicle state alert apparatus.

Alert controller 212 causes vehicle exterior alert apparatus 150 and in-vehicle apparatuses 170 to make a state alert for communicating the state determined by state determiner 111. Alert controller 112 also controls a travel state of vehicle 200 in accordance with the state determined by state determiner 111. Alert controller 112 outputs a control signal for causing vehicle exterior alert apparatus 150, in-vehicle apparatuses 170, and travel controller 160 to operate in accordance with the result of the determination by state determiner 111. The “state alert” mentioned here is an alert made automatically by vehicle state alert apparatus 210 after determining the state of the driver and the state of vehicle 200, and does not include alerts made in response to an operation made by the driver in response to a determination made by the driver. Passing, sounding the horn, and so on can be given as examples of alerts made in response to an operation by the driver. Additionally, travel performed in accordance with the determination result are speed control for reducing accidents, moving to a safe location and stopping, and so on.

In-vehicle apparatuses 170 are various devices included in vehicle 200 and which can make an alert to the driver or an occupant of vehicle 200. In Embodiment 2, light emitter 171, display 172, second audio outputter 173, air conditioning device 174, lighting device 175, steering wheel 176, and safety apparatus 177 are included as in-vehicle apparatuses 170 capable of making an alert. However, in-vehicle apparatuses 170 are not limited thereto, and may be a seat, a window, or the like.

Light emitter 171 is provided in, for example, an instrument panel, and makes an alert to the driver by emitting light. Display 172 is a display device capable of displaying various types of information to the driver, such as a navigation device, a heads-up display, or the like. Second audio outputter 173 outputs audio to the driver, such as a buzzer sound, an alert sound, a guidance sound, or the like. Air conditioning device 174 controls the temperature, airflow, a location where the temperature and airflow are controlled, and so on within vehicle 200.

Lighting device 175 includes a light source such as an LED, and is installed in the ceiling of the vehicle, the instrument panel, a pad part of the steering wheel, or the like. Safety apparatus 177 is a locking mechanism for locking the doors of vehicle 200, a seatbelt, or the like.

### 2-2. Operations

Operations of vehicle state alert apparatus 210 according to Embodiment 2 will be described next.

### 2-2-1. Flow of Operations

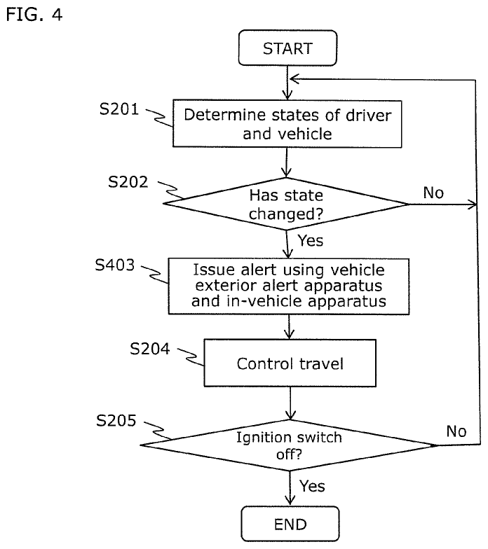

FIG. 4 is a flowchart illustrating an example of operations for the state alert according to Embodiment 2. In FIG. 4, operations that are the same as in the flowchart illustrated in FIG. 2 are given the same reference signs, and will not be described.

If it is determined that the state has changed (“Yes” in step S202), state determiner 111 outputs the result of the determination (the first state, the second state, or another state) to alert controller 212. Alert controller 212 causes vehicle exterior alert apparatus 150 and in-vehicle apparatuses 170 to make a state alert for communicating the state determined by state determiner 111. Alert controller 212 may cause vehicle exterior alert apparatus 150 and in-vehicle apparatuses 170 to make different types of alerts. Vehicle exterior alert apparatus 150 and in-vehicle apparatuses 170 may be caused to make the same type of state alert, or may be caused to make different types of state alerts. Alert controller 212 performs control so that the state alerts are made in formats in which the alert for the first state has a higher urgency than the alert for the second state. Note that alert controller 212 may perform control so that the state alert is made to the exterior of the vehicle only when the state has changed to the first state (step S403).

### 2-2-2. Examples of Operations

The state alerts using vehicle exterior alert apparatus 150 are the same as in Embodiment 1, and thus the following will describe state alerts made by alert controller 212 using in-vehicle apparatuses 170. Alert controller 212 makes at least one of the following state alerts in order to communicate the state determined by state determiner 111. Alert controller 212 may cause a plurality of in-vehicle apparatuses 170 to make state alerts in tandem with each other.

### Alert Using Light Emitter

Alert controller 212 causes light emitter 171 to make a state alert for communicating the state determined by state determiner 111. Alert controller 212 outputs a control signal to light emitter 171. The control signal includes parameter information such as the brightness, color, and display interval of the light emitted by light emitter 171. Alert controller 212 controls at least one of the parameter information according to the state determined by state determiner 111.

Alert controller 212 may control light emitter 171 only when making an alert of the first state. For example, alert controller 212 may cause light emitter 171 to change brightness only when the first state has been determined. Alternatively, alert controller 212 may cause light emitter 171 to change color only when making an alert of the first state. Furthermore, alert controller 212 may cause light emitter 171 to flash only when making an alert of the first state.

Alert controller 212 may cause light emitter 171 to perform different types of alerts between the first state and the second state. Alert controller 212 may control the brightness of light emitter 171 when making an alert of the first state to be brighter than the brightness used when making an alert of the second state. Additionally, alert controller 212 may control the interval of flashing of light emitter 171 when making an alert of the first state to be shorter than the interval of flashing used when making an alert of the second state. Furthermore, alert controller 212 may make the color of the light emitted by light emitter 171 when making an alert of the first state a color evoking a greater sense of urgency (e.g., red or a color close to red) than the color of the light emitted when making an alert of the second state.

### Alert Using Display

Alert controller 212 causes display 172 to make a state alert for communicating the state determined by state determiner 111. Alert controller 212 causes display 172 to display text, an image, or the like indicating the state alert. Alert controller 212 may control the display in display 172 only when making an alert of the first state. Additionally, alert controller 212 may cause different details to be displayed in display 172 between when making an alert of the first state and when making an alert of the second state. Alert controller 212 may use symbols, colors, images, text, or the like communicating a higher level of urgency when making an alert of the first state than when making an alert of the second state.

For example, alert controller 212 displays an image expressing the first state or the second state in an intuitive manner in a heads-up display.

Additionally, alert controller 212 may display the details of travel control performed by travel controller 160 in display 172.

### Alert Using Second Audio Outputter

Alert controller 212 causes second audio outputter 173 to make a state alert for communicating the state determined by state determiner 111. Alert controller 212 may cause second audio outputter 173 to output audio only when making an alert of the first state. Additionally, alert controller 212 may cause the audio to be output at a higher volume when making an alert of the first state than when making an alert of the second state. Furthermore, alert controller 212 may cause second audio outputter 173 to output different audio for the first state and for the second state. Furthermore, alert controller 212 may cause second audio outputter 173 to output audio at different intervals for the first state and for the second state. At this time, the output interval of the audio for the first state may be made shorter than the output interval of the audio in the second state.

Additionally, alert controller 212 may cause second audio outputter 173 to output details of the travel control performed by travel controller 160 as audio.

### Alert Using Safety Apparatus

Alert controller 212 controls a safety apparatus in accordance with the state determined by state determiner 111. In the present embodiment, alert controller 212 controls the tension of a seatbelt serving as safety apparatus 177. For example, alert controller 212 may control an amount of winding of the seatbelt so as to increase the tension of the seatbelt only when making an alert of the first state. Additionally, alert controller 212 may perform control to increase the tension of the seatbelt (increase the amount of winding) more when making an alert of the first state than when making an alert of the second state. Increasing the tension of the seatbelt can alert the driver of the states in a tactile manner. Increasing the tension of the seatbelt also makes it possible to secure (restrain) the driver to the seat to protect the driver's cervical spine in the event of a collision. The tension of the seatbelts may be increased for occupants aside from the driver as well.

### Alert Using Air Conditioning Device

Alert controller 212 causes air conditioning device 174 to make a state alert for communicating the state determined by state determiner 111. Alert controller 212 causes air conditioning device 174 to change the cabin temperature of vehicle 200 only when making an alert of the first state. Alternatively, alert controller 212 may cause air conditioning device 174 to lower the cabin temperature of vehicle 200 only when making an alert of the first state. Alternatively, alert controller 212 may control air conditioning device 174 to lower the cabin temperature more when making an alert of the first state than when making an alert of the second state. Alternatively, alert controller 212 may cause air conditioning device 174 to operate (turn the power on) when the power of air conditioning device 174 is turned off and only when making an alert of the first state. Alternatively, alert controller 212 may cause air conditioning device 174 to operate (turn the power on) when air conditioning device 174 is turned off and when making an alert of the first state or the second state. At this time, air conditioning device 174 may be controlled to emit cool air in the case of the first state. Additionally, alert controller 212 may control air conditioning device 174 to increase the strength of the air flow only when making an alert of the first state. Additionally, alert controller 212 may control air conditioning device 174 near the driver's seat to lower the temperature or strengthen the airflow.

### Alert Using Lighting Device

Alert controller 212 causes lighting device 175 to make a state alert for communicating the state determined by state determiner 111. Alert controller 212 outputs a control signal to lighting device 175. The control signal includes parameter information such as the brightness, color, and display interval of light emitted by lighting device 175. Alert controller 212 controls at least one of the parameter information according to the state determined by state determiner 111.

Alert controller 212 may control lighting device 175 only when making an alert of the first state. For example, alert controller 212 may cause lighting device 175 to change brightness only when the first state has been determined. Alternatively, alert controller 212 may cause lighting device 175 to change color only when making an alert of the first state. Furthermore, alert controller 212 may cause lighting device 175 to flash only when making an alert of the first state.

Alert controller 212 may cause lighting device 175 to perform different types of alerts between the first state and the second state. Alert controller 212 may control the brightness of lighting device 175 when making an alert of the first state to be brighter than the brightness used when making an alert of the second state. Additionally, alert controller 212 may control the interval of flashing of lighting device 175 when making an alert of the first state to be shorter than the interval of flashing used when making an alert of the second state. Furthermore, alert controller 212 may make the color of the light emitted by lighting device 175 when making an alert of the first state a color evoking a greater sense of urgency (e.g., red or a color close to red) than the color of the light emitted when making an alert of the second state.

Note that alert controller 212 may set the brightness of the light emitted by lighting device 175 in accordance with the brightness outside the vehicle. The brightness of the light may be set lower the darker it is outside the vehicle, e.g., by setting the brightness of the light to be lower at night than during the day.

### Alert Using Steering Wheel

Alert controller 212 vibrates steering wheel 176 in accordance with the state determined by state determiner 111. Alert controller 212 may control the strength, interval, or the like of the vibration of steering wheel 176.

Alert controller 212 may vibrate steering wheel 176 only when making an alert of the first state. For example, alert controller 212 may change the strength of the vibration of steering wheel 176 only when making an alert of the first state. Alert controller 212 may vary the vibration state of the steering wheel between an alert of the first state and an alert of the second state. Alert controller 212 may control the vibration of steering wheel 176 when making an alert of the first state to be stronger than the vibration used when making an alert of the second state. Additionally, alert controller 212 may control the interval of vibrations of steering wheel 176 when making an alert of the first state to be shorter than the interval of vibrations used when making an alert of the second state.

### 2-3. Effects, etc.

As described above, according to the present embodiment, alert controller 212 also causes in-vehicle apparatuses 170, which are included in vehicle 200, to make a state alert. This makes it possible to communicate the state of the driver and the state of vehicle 200 to the driver. This makes it possible to encourage the driver to drive safely.

Additionally, in the present embodiment, alert controller 212 causes vehicle exterior alert apparatus 150 and in-vehicle apparatuses 170 to make different types of alerts for the state alerts. Accordingly, types of alerts that are respectively suited to the driver driving vehicle 200, and to vehicles, pedestrians, and the like outside vehicle 200, can be made.

Additionally, in the present embodiment, alert controller 212 causes second audio outputter 173 to output audio in accordance with the state determined by state determiner 111. This makes it possible for the driver to receive the state alert even without looking at the device making the in-vehicle alert. The driver can therefore receive the alert while looking to the front of vehicle 200, which makes it possible to avoid interfering with the driving. The driver can also notice the alert even when in a highly-drowsy state.

Additionally, alert controller 212 causes at least one of display 172 and second audio outputter 173 to output the details of travel control performed by travel controller 160. This makes it possible for the driver, or an occupant other than the driver, to know the current travel state or a future travel state of vehicle 200. In particular, if the driver has been rendered unconscious and is unable to drive, an occupant aside from the driver can know the travel state or the future travel state of vehicle 200, which provides peace of mind to the occupant.

Additionally, in the present embodiment, alert controller 212 controls a safety apparatus in accordance with the state determined by state determiner 111. This makes it possible to secure (restrain) the driver and occupants aside from the driver in their seats when in a state in which an emergency situation is likely to occur. This makes it possible to protect the driver's cervical spine and so on in the event of a collision. This is particularly effective when alert controller 212 controls the travel state, such as deceleration and steering, independent of the driver's intentions. Additionally, tightening the seatbelts makes it more likely that everyone will realize that the vehicle may decelerate, which makes it possible to them to brace for impact.

Additionally, in the present embodiment, alert controller 212 controls an air conditioning device to make a state alert in accordance with the state determined by state determiner 111. Additionally, in the present embodiment, alert controller 212 controls a lighting device to make a state alert in accordance with the state determined by state determiner 111. Additionally, in the present embodiment, alert controller 212 vibrates a steering wheel in accordance with the state determined by state determiner 111. This makes it possible for the driver to receive the alert even without looking at the device making the in-vehicle alert. The driver can therefore receive the alert while looking to the front of vehicle 200, which makes it possible to avoid interfering with the driving.

### Other Embodiments

The foregoing embodiments have been described as examples of the technique disclosed in the present application. However, the technique in the present disclosure is not limited thereto, and can also be applied in embodiments in which modifications, replacements, additions, or omissions have been made as appropriate. New embodiments can also be made by combining the constituent elements described in the foregoing embodiments with those described in the other embodiments below.

Examples of other embodiments will therefore be described next.

Although the embodiments describe the state determiner as determining a distracted state as a state of the driver, the driver state is not limited thereto. A state of looking to the side, a state of driving while focusing on the vehicle surroundings, i.e., in a place where many people are around the vehicle, such as a downtown area, an intoxicated state, an unconscious state, or the like may be determined as states of the driver.

Additionally, although an extended travel state is determined as a state of the vehicle by the state determiner, the state of the vehicle is not limited thereto. The state of the vehicle may include a driving mode, being in a hurry, abnormal speed, low fuel, low tire pressure, slipping, approaching an obstruction, successfully entering another lane, traveling backward, and the like. Here, “driving mode” is, for example, a sport mode, an eco mode, an autonomous driving mode, a semi-autonomous driving mode, or the like. “Abnormal speed” refers to a state in which the vehicle is traveling above or below the speed limit. “Being in a hurry” is a state in which the driver is in a hurry for a reason such as not being able to arrive at the destination by the scheduled time, for example. “Low fuel” is a state in which the vehicle has little fuel remaining. “Low tire pressure” is a state in which at least one of the tires of the vehicle has low air pressure. The states may also include a state where the vehicle is undergoing almost no meandering. Alternatively, the states may include a state where the vehicle is meandering significantly.

Control may also be performed so that an upper limit speed is set so as to reduce the likelihood of an accident when the state determiner has determined that the driver is in a hurry. The upper limit speed may be set based on the speed limit of the road on which the vehicle is traveling, traffic conditions, and the like.

Although the alert controller causes the vehicle exterior alert apparatus and the in-vehicle apparatus to make an alert of the state of the driver and the state of the vehicle, it is also possible to make an alert of only one of those states.

In Embodiment 2, the driver is alerted by vibrating the steering wheel, but a pedal, a seat, or the like may be vibrated instead.

The alerts from a plurality of the in-vehicle apparatuses may be linked to each other. For example, the light emitter may be caused to emit light, or the second audio outputter may be caused to output audio, along with the steering wheel vibrating.

Additionally, alert controller 212 may link the alert from vehicle exterior alert apparatus 150 with the alert from in-vehicle apparatuses 170. For example, the tension of the seatbelt may be controlled when vehicle 200 is stopped.

Additionally, alert controller 212 may control only in-vehicle apparatuses 170 to make an alert, without controlling vehicle exterior alert apparatus 150.

The foregoing embodiments have been described as examples of the technique according to the present disclosure. The accompanying drawings and detailed descriptions have been provided to that end.

As such, the constituent elements indicated in the accompanying drawings and the detailed descriptions include not only constituent elements necessary to solve the technical problem, but also constituent elements not necessary to solve the problem but used to exemplify the above-described technique. Those unnecessary constituent elements being included in the accompanying drawings, the detailed description, and so on should therefore not be interpreted as meaning that the unnecessary constituent elements are in fact necessary.

Additionally, the foregoing embodiments are provided merely as examples of the technique according to the present disclosure, and thus many changes, substitutions, additions, omissions, and the like are possible within the scope of the claims or a scope equivalent thereto.

Further Information about Technical Background to this Application

The disclosure of the following Japanese Patent Application including specification, drawings and claims are incorporated herein by reference in its entirety: Japanese Patent Application No. 2019-228314 filed on Dec. 18, 2019.

### INDUSTRIAL APPLICABILITY

The present disclosure is useful in technology which is installed in a vehicle and communicates a state of a driver driving the vehicle and a state of the vehicle to the vehicle interior and the vehicle exterior.

1. A vehicle state alert apparatus which is used in a vehicle including a vehicle exterior alert apparatus capable of making an alert to a person outside the vehicle, the vehicle state alert apparatus comprising:
a state determiner that determines a state of a driver of the vehicle and a state of the vehicle; and
an alert controller that causes the vehicle exterior alert apparatus to make a state alert for communicating the states determined by the state determiner,
wherein the states determined by the state determiner include a first state in which an emergency situation is likely to occur and a second state in which the first state is likely to occur, and
the alert controller controls a travel state of the vehicle in accordance with the states determined by the state determiner.

2. The vehicle state alert apparatus according to claim 1,
wherein the first state is a highly-drowsy state in which a drowsiness level of the driver is at least a predetermined level, and
the second state is an extended travel state in which the vehicle has been traveling for at least a predetermined length of time.

3. The vehicle state alert apparatus according to claim 1,
wherein at least while the driver is driving the vehicle, the alert controller causes the vehicle exterior alert apparatus to continually make a state alert based on a result of the determination by the state determiner.

4. The vehicle state alert apparatus according to claim 1,
wherein when making an alert of the first state, the alert controller causes the vehicle to decelerate.

5. The vehicle state alert apparatus according to claim 1,
wherein when making an alert of the first state, the alert controller causes the vehicle to stop.

6. The vehicle state alert apparatus according to claim 1,
wherein the vehicle exterior alert apparatus includes at least one light emitter that emits light, and
the alert controller causes the vehicle exterior alert apparatus to make the state alert by causing the light emitter to emit light.

7. The vehicle state alert apparatus according to claim 1,
wherein the vehicle exterior alert apparatus includes at least one first audio outputter that outputs audio, and
the alert controller causes the vehicle exterior alert apparatus to make the state alert by causing the first audio outputter to output audio.

8. The vehicle state alert apparatus according to claim 1,
wherein the vehicle exterior alert apparatus is a communication device for communicating with the exterior, and
the alert controller makes the state alert to an external device via the communication device.

9. The vehicle state alert apparatus according to claim 1,
wherein the vehicle further includes an in-vehicle apparatus capable of making an alert to the driver, and
the alert controller causes the in-vehicle apparatus to make the state alert as well.

10. The vehicle state alert apparatus according to claim 9,
wherein the alert controller causes the vehicle exterior alert apparatus and the in-vehicle apparatus to make the state alert using different types of alerts.

11. The vehicle state alert apparatus according to claim 9,
wherein the in-vehicle apparatus includes a second audio outputter, and
the alert controller causes the second audio outputter to output audio in accordance with the state determined by the state determiner.

12. The vehicle state alert apparatus according to claim 9,
wherein the in-vehicle apparatus includes a safety apparatus, and
the alert controller controls the safety apparatus in accordance with the state determined by the state determiner.

13. The vehicle state alert apparatus according to claim 9,
wherein the in-vehicle apparatus includes an air conditioning device, and
the alert controller controls the air conditioning device in accordance with the state determined by the state determiner.

14. The vehicle state alert apparatus according to claim 9,
wherein the in-vehicle apparatus includes a lighting device, and
the alert controller controls the lighting device in accordance with the state determined by the state determiner.

15. The vehicle state alert apparatus according to claim 9,
wherein the in-vehicle apparatus includes a steering wheel, and
the alert controller vibrates the steering wheel in accordance with the state determined by the state determiner.

16. A vehicle state alert method which is used in a vehicle including a vehicle exterior alert apparatus capable of making an alert to a person outside the vehicle, the vehicle state alert method comprising:
determining a state of a driver of the vehicle and a state of the vehicle; and
causing the vehicle exterior alert apparatus to make a state alert for communicating the determined states, and controlling a travel state of the vehicle in accordance with the determined states,
wherein the determined states includes a first state in which an emergency situation is likely to occur and a second state in which the first state is likely to occur.
